(19) United States
(12) Patent Application Publication
(10) Pub. No.: US 2016/0123380 A1
(43) Pub. Date: May 5, 2016

(54) CONNECTING ROD, METHOD FOR MANUFACTURING SUCH A ROD AND AERONAUTIC FLOOR STRUCTURE INCORPORATING SAME

(71) Applicant: HUTCHINSON, Paris (FR)

(72) Inventors: Michaël Godon, Montargis (FR); Cristina Gonzalez-Bayon, Amilly (FR); Bertrand Florentz, Paucourt (FR); Jean-Pierre Ciolczyk, Montargis (FR)

(73) Assignee: HUTCHINSON, Paris (FR)

(21) Appl. No.: 14/895,898

(22) PCT Filed: Jun. 3, 2014
(86) PCT No.: PCT/IB2014/061919

§ 371 Date: Dec. 3, 2015

(30) Foreign Application Priority Data
Jun. 5, 2013 (FR) 1355174

(51) Int. Cl. F16C 7/02; B29C 65/54; F16B 11/00; B29C 65/48; B64C 1/18; F16C 11/04

(52) U.S. Cl. CPC F16C 7/02; B64C 1/18; F16C 11/04; F16B 11/008; B29C 65/4835; B29C 65/542; B29C 65/544; B29L 2031/06

(57) ABSTRACT

The present invention relates to a connecting rod, an aeronautic floor structure incorporating it, and a method for manufacturing this connecting rod. The invention applies to a connecting rod suitable for reacting primarily axial forces, in particular in the aeronautics field.

This connecting rod comprises a tubular body with two ends and two heads for connecting those ends to adjacent structures and that is suitable for reacting primarily axial forces, each head comprising an end-piece flared toward the body and glued on the latter in a gluing interface.

According to the invention, the connecting rod comprises at least one first sealing gasket mounted radially between and against the body and the end-piece of each head, axially toward the inside of the gluing interface. The connecting rod can be manufactured by assembling the first seal in contact with each end-piece and a first inner or outer face of an end zone opposite the body, then gluing each end-piece on the body, by injection and suction of a glue radially between the body and each end-piece and axially toward the outside of this first sealing gasket.

The present invention relates to a connecting rod, an aeronautic floor structure incorporating it, and a method for manufacturing this connecting rod. The invention generally applies to a connecting rod suitable for reacting primarily axial forces, in particular but not exclusively in the aeronautics field, this connecting rod advantageously being able to be structural and being able to be made from composite materials.

The current composite connecting rods for reacting axial forces typically have an elongated shape with a central primary body provided with two heads with flared end-pieces respectively ending with ends for connecting to structures in particular creating axial traction-compression forces, the connection typically being done by connecting axes respectively mounted through these ends.

Document WO-A1-2010/024994 describes such a connecting rod whose composite body is assembled by gluing to the end-pieces of its connecting heads, by means of annular inserts covering the ends of the body and covered by these end-pieces.

The connecting rods described in this document have the drawback of having a relatively high mass and manufacturing cost, in particular due to the inserts required for their assembly.

More generally, one major drawback of the composite connecting rods known at this time lies in their high mass, which is related on the one hand to the processing method used, typically resin transfer molding (RTM) or preimpregnated compression molding using a bladder, and on the other hand, to the reinforcement of these connecting rods to give them sufficient strength with respect to impacts and any manufacturing defects, since the tolerance for damage and manufacturing defects is a characteristic specifically required for composite parts.

One aim of the present invention is to propose a connecting rod resolving the aforementioned drawbacks, that comprises a tubular body with two ends and two heads for connecting those ends to adjacent structures and that is suitable for reacting primarily axial forces (i.e., traction-compression forces) generated by these structures, each head comprising an end-piece flared toward the body and glued on the latter in a gluing interface.

To that end, a connecting rod according to the invention comprises at least one first sealing gasket mounted radially between and against the body and the end-piece of each head, axially toward the inside of the gluing interface.

The expressions that mention that a first element of a connecting rod according to the invention is situated “axially toward/inside” or “axially toward/outside” a second element of this connecting rod typically means, in the present description, that this first element is situated, in reference to the longitudinal axis of symmetry of the connecting rod body, toward the inside or toward the outside of the body (i.e. toward the center of that body or toward the heads), respectively.

It will be noted that this first sealing gasket in particular makes it possible to ensure constant and balanced radial play and radial positioning wedging of the connecting rod body relative to the connecting heads, as well as sealing during gluing, as will be described below.

According to another feature of the invention, said first sealing gasket, which is annular and preferably an O-ring, can be mounted in a first groove formed at an axially inner end of each end-piece.

It will be noted that the connecting rods according to the invention can advantageously be assembled without screwing end-pieces on the body, and with no intermediate annular insert between the body and each end-piece, which is thus directly glued on that body, unlike the aforementioned document.

According to another preferred feature of the invention, each end-piece comprises a globally frustoconical flared portion extended axially toward the inside by a globally cylindrical axial portion, the connecting rod incorporating, axially toward the outside of said first sealing gasket, injection and/or suction means of a glue that are able to form said gluing interface on the axial portion of each end-piece, this glue having a viscosity at 25° C. preferably less than or equal to 10 Pa.s (for example approximately 1 Pa.s).

It will be noted that this first O-ring makes it possible to ensure sealing of the body-heads assembly during the suctioning, preferably done by vacuum drawing, and also to control the optimal quantity and thickness of glue in the gluing interface, which can advantageously be comprised between 0.1 mm and 0.5 mm.

It will also be noted that this first O-ring makes it possible to protect the glue against aging due to the surrounding fluids (e.g., condensates, water, dispersions of hydraulic liquids such as phosphate esters of the “Skydrol” type), during the usage time of the connecting rod during operation.

As a non-limiting example, this glue can be of the bi-component epoxy resin type, cross-linkable at ambient temperature or heat activated, having specified that other glues, for example bi-component cross-linkable at ambient temperature or heat-activated, can be used as long as they have this reduced viscosity.

Preferably, said injection and suction means comprise a first series of orifices circumferentially spaced apart to inject or suction glue and a second series of orifices circumferentially spaced apart to suction or inject the injected glue or to suction through the first series of orifices, these two series being axially separate from one another.

Still more preferably, said first series of orifices is formed through each end-piece substantially at the junction between said flared portion and said axial portion, said second series of orifices being formed through the axial portion or else through said body facing the axial portion.

Still more preferably, said first series is formed by first orifices crossing axially through each end-piece radially facing said gluing interface between said body and this end-piece, and said second series is formed by second orifices crossing radially through said axial portion of each end-piece or else said body.

According to a first preferred embodiment of the invention, said second orifices cross through said axial portion of each end-piece radially outside said body, which is thus topped by this axial portion while being fitted in the end-piece, the glue overlapping at least one radially outer face of the body.

According to a second embodiment of the invention, said second orifices cross through said body radially outside said axial portion of each end-piece, and each end of the body is wedged in an axial groove of the corresponding end-piece, this axial groove being radially inwardly defined by the axial portion and radially outwardly defined by an outer axial wall that extends said flared portion parallel to the axial portion over a shorter distance than this axial portion, the glue covering at least one radially inner face of the body.

According to another optional and particularly advantageous feature of the invention, the connecting rod can further comprise, for the connection of each end-piece to said body, at least one annular second sealing gasket or mastic, preferably an O-ring, that is mounted in a second groove of each end-piece formed axially facing said axial portion and the corresponding end of said body, said first sealing gasket and this second sealing gasket or mastic being mounted radially on either side of the body and axially opposite one another, the glue covering both the radially inner and outer faces of the body.

It will be noted that the preferred use of these first and second O-rings bearing against the two outer and inner faces, respectively, of the connecting rod body makes it possible to further improve:
the implementation of the gluing by vacuum drawing,
the protection of the gluing interface with respect to the environment of the connecting rod,
the guiding of the body in each end-piece, and
the gluing interface obtained by increasing the surface area of the glue present at that interface on the two faces of the body.

According to said first embodiment of the invention, for each end-piece, said second groove can extend axially from said flared portion radially inside said axial portion, said second sealing gasket or mastic pressing against a radially inner face of the corresponding end of said body.

According to said second embodiment of the invention, for each end-piece, said second groove can extend over said outer axial wall radially outside said axial portion, said second sealing gasket or mastic pressing against a radially outer face of the corresponding end of said body.

According to another feature of the invention, said body, which is for example pultruded, can be based on at least one ply comprising first fibers primarily parallel to a longitudinal axis of symmetry of the body and impregnated with a thermoplastic or thermosetting matrix, and on second wrapping fibers wound in a spiral obliquely around these first fibers, and each end-piece (metal or not) can then be glued on said body by infusion of a resin, for example epoxy, on each end-piece.

It will be noted that pultrusion is only one possibility among others that can be considered to shape the connecting rod body according to the invention, having specified that the pultruded body has the advantage of contributing significantly to lightening the connecting rod of the invention, since pultrusion advantageously makes it possible to give the fibers a primary orientation in the longitudinal direction of the connecting rod body.

It will also be noted that the second wrapping fibers inclined optimally advantageously make it possible to give the connecting rod a satisfactory crushing and impact resistance, and can be identical in nature or different with respect to the first fibers of the body, based on needs.

The separation between these first globally unidirectional and axial inner fibers and these second outer wrapping fibers primarily intended to protect these first fibers appears particularly advantageous.

Alternatively, said body and said end-pieces can be based on at least one thermoplastic material, and each end-piece can then not only be glued on the body, but also be mechanically attached to the latter by permanent deformation of the body radially against each end-piece by crimping able to form an assembly stop (i.e., a mechanical stop) for the junction between each end-piece and the advantageously pultruded body.

According to another feature of the invention, each of said heads comprises a connecting end for connecting to said structures that extends said corresponding end-piece axially toward the outside of the body and that is:
of the fixed type, the connecting end in the form of a double yoke including two parallel connecting walls that can be formed in a single piece with the end-piece on either side of the median longitudinal plane of the body and that are respectively provided with opposite orifices designed to be crossed through by a connecting pin to one of these structures (alternatively, a single yoke with a single connecting wall can be used), or
of the adjustable type, the connecting end including a tubular support inserted adjustably in the end-piece and ending with a double yoke with two parallel connecting walls on either side of the longitudinal median plane of the body, these walls respectively being provided with opposite orifices designed to be crossed through by a connecting pin to one of these structures (alternatively, a single yoke can also be used).

An aeronautic floor structure according to the invention is such that it includes at least one connecting rod as defined above.

A manufacturing method according to the invention for a connecting rod as defined above comprises the following steps:

a) assembling said at least one first sealing gasket in contact with each of said end-pieces and a first radially inner or outer face of an end zone opposite said body, then

b) gluing each end-piece on the body, by injection and suction—preferably by vacuum drawing—of a glue radially between the body and each end-piece and axially toward the outside of this first sealing gasket, the glue having a viscosity at 25° C. preferably less than or equal to 10 Pa.s (for example, approximately 1 Pa.s).

According to another optional feature of the invention, this method may further comprise, in step a), mounting at least one second sealing gasket or mastic in contact with each end-piece and a radially outer or inner second face of said body opposite said first face, said first sealing gasket and said second sealing gasket or mastic thus being mounted radially on either side of the body and axially opposite one another facing a globally cylindrical axial portion of each end-piece.

According to another feature of the invention, this method can advantageously comprise, before step a), forming by pultrusion of said body, which can have a base of at least one ply of fibers impregnated with a thermoplastic or thermosetting matrix, and step b) for gluing can be implemented by infusion of a resin, for example epoxy, in contact with each end-piece.

In general, it will be noted that each end-piece according to the invention can be metal (for example aluminium) or not, in the latter case being able to be of the plastic or composite type (with a base of a thermoplastic or thermosetting matrix).

If the connecting rod body is of the composite type, its fiber impregnation matrix can advantageously be chosen to be thermosetting, for example being based on at least one epoxy resin, or thermoplastic, for example based on at least one polymer chosen from the group made up of polyolefins, polyamide (PA), polyetherimides (PEI), polyarylimides (PAI), polyphenylene sulfide (PPS), polyaryletherketones (PAEK), polyether sulfones (PDF), polyetheretherketones (PEEK), polyetherketoneketones (PEKK) and mixtures thereof. It will be noted that it is also possible to use, for this thermoplastic matrix, mixtures of very different polymers (for example, two thermoplastic polymers that are respectively polar and apolar) with or without comptabilizers and optionally combined with other additives. The fibers usable in a composite connecting rod body can for example be based on carbon, non-limitingly.

If metal end-pieces and carbon fibers are used for the connecting rod body, it will be noted that said first sealing gasket and optionally said second sealing gasket make(s) it possible to oppose the galvanic corrosion of each end-piece by these carbon fibers.

It will be noted that other polymers and fibers can be used to form the connecting rod body, provided that they give the connecting rod an impact resistance and sufficient ability to react axial forces.

It will be noted that a connecting rod according to the invention has, in particular owing to materials having intrinsic properties of self-extinguishing, low density, smoke toxicity and, due to a particularly high elongation at break for the thermoplastic matrices, an improved impact resistance, significantly increased lightening for a same given value of these properties (e.g., impact resistance) relative to the known composite structural connecting rods.

This connecting rod according to the invention thus in particular has, due to said first primarily unidirectional fibers in the axis of the connecting rod that are protected by an outer layer of said second fibers dedicated to impact resistance, improved mechanical properties regarding the reaction of axial forces and impact resistance, which appears to result in mass savings on the connecting rod to obtain determined properties.

Other features, advantages and details of the present invention will emerge from reading the following description of several example embodiments of the invention, provided as an illustration and non- limitingly, the description being done in reference to the attached drawings, in which:

FIG. 1 is an exploded lateral diagrammatic view showing the assembly principle of a connecting rod according to the invention,

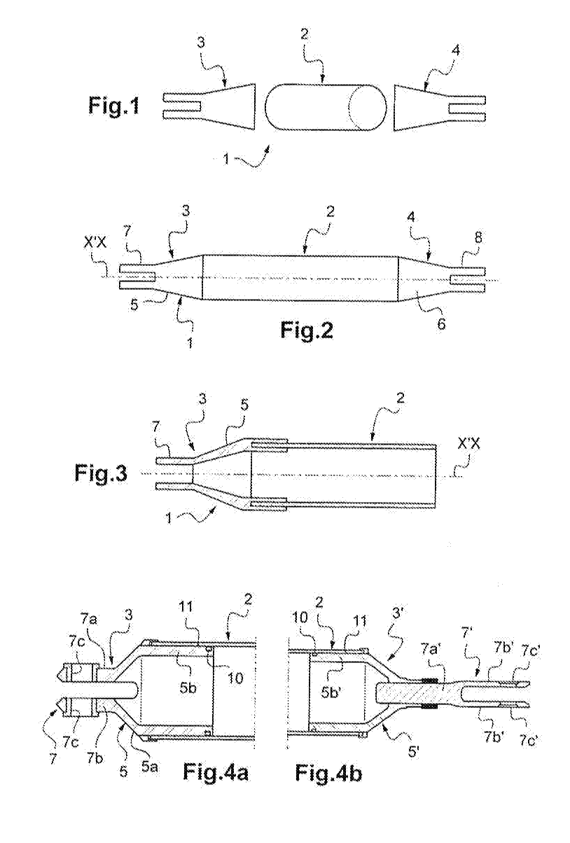

FIG. 2 is an assembled diagrammatic side view of the connecting rod of FIG. 1,

FIG. 3 is a partial diagrammatic axial sectional view of an end zone of a connecting rod according to one example of the invention, the sealing gasket combined with the gluing interface not being shown,

FIG. 4a is a partial diagrammatic axial sectional view of the end zone of a connecting rod according to the second embodiment of the invention, further showing a head of the fixed type,

FIG. 4b is a partial diagrammatic axial sectional view of the end zone of another connecting rod according to this second embodiment of the invention, further showing an adjustable-type head,

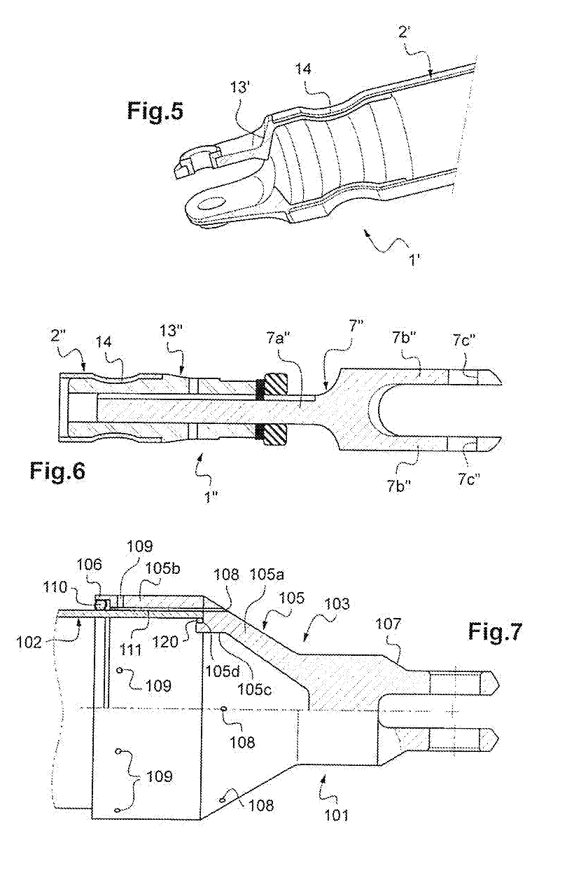

FIG. 5 is a partial view both in perspective and axial section of an end zone of another connecting rod with a fixed head similar to that of FIG. 4a,

FIG. 6 is a partial axial sectional view of an end zone of another connecting rod according to the invention with an adjustable head similar to that of FIG. 4b,

FIG. 7 is a partial diagrammatic axial half-sectional view of an end zone of a connecting rod according to the first embodiment of the invention, showing the first and second sealing gaskets and the gluing interface between the body and the end-piece,

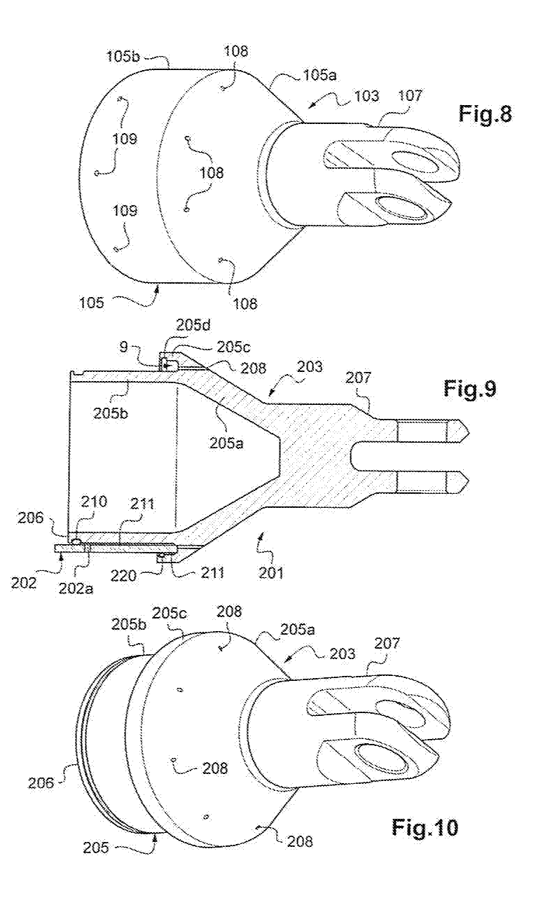

FIG. 8 is a diagrammatic perspective view of the end-piece according to this first embodiment of FIG. 7,

FIG. 9 is a partial diagrammatic axial half-sectional view of an end zone of a connecting rod according to the second embodiment of the invention, showing the first and second sealing gaskets and the gluing interface between the body and end-piece, and

FIG. 10 is a diagrammatic perspective view of the end-piece according to this second embodiment of FIG. 9.

As illustrated in particular in FIGS. 1-3 and 4a, a connecting rod 1 according to the invention includes a convex body 2 advantageously formed by pultrusion and two connecting parts 3 and 4 glued to this body advantageously using an infusion technique and designed to connect the connecting rod 1 to adjacent structures via two connecting pins (not shown) to be mounted in these heads 3 and 4, respectively. As previously explained, the body 2 can be of the composite type while being made from fiber plies that are primarily axial (i.e., the majority of which are parallel to the longitudinal axis of symmetry X′X of the connecting rod 1) such as carbon fibers, for example, impregnated with a thermoplastic or thermosetting matrix, for example epoxy resin in the second case, with winding in a spiral on these plies of one or more wrapping fibers to increase the robustness of the connecting rod 1 in terms of crushing or impacts. The heads 3 and 4 can for example be made from metal (e.g., aluminium) or not (e.g. a thermoplastic or thermosetting material).

As shown in FIGS. 3 and 4a, each fixed-type head 3, 4 forms a single-piece double yoke comprising an end-piece 5, 6 diverging toward the body 2 and a connecting end 7, 8 extending the end-piece 5, 6 axially outwardly. Each end-piece 5, 6 comprises a frustoconical flared portion 5a and an axial portion 5b that extends axially inward and that defines the assembly zone with the body 2. Each connecting end 7, 8 includes two parallel flat walls 7a and 7b that are spaced apart on either side of the axis X′X and that are pierced with two facing orifices 7c (see FIG. 4a) designed to receive one of the connecting axes.

In the example of FIG. 4a, which diagrammatically illustrates the second embodiment of the invention, one can see that each fixed head 3, 4 has an axial groove 9 (visible in FIG. 9) in which both ends of the body 2 are wedged, with interposition of a first annular sealing gasket 10 and, axially toward the outside of this seal 10, a gluing interface 11 that will be described more precisely in reference to this FIG. 9.

In the alternative of FIG. 4b, which also shows the body 2 wedged in an axial groove 9 of the axial portion 5b′ of each end-piece 5′, one can see that each adjustable-type head 3′ has its frustoconical end-piece 5′ that also diverges toward the body 2, but that is not extended in a single piece by the connecting end 7′, which is attached by insertion in the end-piece 5′. This end 7′ for example includes a tubular support 7a′ inserted adjustably in the end-piece 5′ and ending with two parallel connecting walls 7b′ on either side of the median longitudinal plane of the body 2 containing the axis X′X, these walls 7b′ respectively being provided with facing orifices 7c′ designed to be crossed through by a connecting pin to one of these structures.

FIGS. 5 and 6 respectively illustrate the case of connecting rods 1′ and 1″ made from thermoplastic material(s), with a gluing interface between the body 2′, 2″ and end-piece 13′, 13″, a connecting end 7″ similar to that 7′ of FIG. 4b (i.e., with a tubular support 7a″ provided with parallel connecting walls 7b″ to facing orifices 7c″) being inserted in FIG. 6 in the end-piece 13″. This interface is similar to the interface 11 of FIG. 4b, but also with a mechanical attachment of the crimping type 14 applied to the body 2′, 2″, inside which the end-piece 13′, 13″ has been fitted. This permanent deformation applied to the body 2′, 2″—end-piece 13′, 13″ assembly makes it possible to secure the gluing and favours the tensile strength of this assembly.

FIGS. 7 and 8 illustrate gluing done tightly for a connecting rod 101 according to the first embodiment of the invention, which first comprises positioning a first O-ring 110 in a first groove 106 formed at the axially inner end of each end-piece 105 (each end-piece 105 is in this example formed in a single piece with the fixed connecting end 107 of the corresponding head 103, having specified that an adjustable connecting end 7′ according to FIG. 4b can also be used), the groove 106 being formed on the radially inner face of the axial portion 105b of each end-piece 105 and in the example of FIG. 7 being formed by a radial shoulder.

Each end-piece 105 according to the invention incorporates (see FIG. 8), for the gluing operation the vacuum drawing by injecting a heat-activated glue 111 for example of the epoxy resin type and with a low viscosity (less than 1 Pa.s at 25° C.):
first orifices 108 circumferentially spaced apart to inject or suction the glue 111, which are formed at the junction between the flared portion 105a and the axial portion 105b while crossing axially through that junction and which thus emerge radially facing the annular interstices designed to receive the glue 111 between the tubular body 102 and the radially inner face of the axial portion 105b, and
second orifices 109 circumferentially spaced apart to suction or inject the injected glue 111 or to suction to the first orifices 108, which are formed immediately below the first seal 110 radially through an axially inner zone of the axial portion 105b.

The body 102 is guided inside the end-piece 105 in contact with the first seal 110 to be radially fitted inside the axial portion 105b, until the axially inner end of the body 102 abuts against the junction between the axial portion 105b and the frustoconical portion 105a of the end-piece 105. The first seal 110 then bears on the radially outer face of the body 102.

In order to perform this gluing by vacuum drawing under better conditions, to facilitate the guiding of the body 102 in each end-piece 105, to improve the subsequent protection of the obtained gluing interface 111 with respect the environment and maximize the surface area of this interface 111, in particular, it may be advantageous to provide the end-piece 105 of FIGS. 7 and 8 with an annular second O-ring seal or mastic 120 that is positioned in a second groove 105d of each end-piece 105 so that this second seal 120 bears on the radially inner face of the corresponding end of the body 102 axially opposite the first seal 110. The second groove 105d extends axially from the flared portion 105a over a short distance by a short axial portion 105c, radially inside and opposite the axial portion 105b.

After this gluing by vacuum drawing, the glue 111 covers the outer face of the body 102 and the inner face opposite the axial portion 105b of each end-piece 105, with the exception of the first groove 106, since the annular gluing interface 111 (which can have a thickness from 0.1 mm to 0.5 mm) ends axially outside the first seal 110.

FIGS. 9 and 10 illustrate gluing implemented tightly for a connecting rod 201 according to the second embodiment of the invention, which comprises first positioning a first O-ring 210 in a groove 206 formed in the axially inner end of each end-piece 205 (each end-piece 205 is in this example formed in a single piece with the fixed connecting end 207 of the corresponding head 203, having specified that an adjustable connecting end 7′ according to FIG. 4b can also be used), the groove 206 being formed on the radially outer face of the axial portion 205b of each end-piece 205 and in the example of FIG. 9 being delimited by two radial edges.

Each end-piece 205 according to this second embodiment incorporates (see FIG. 10), for gluing by vacuum drawing by injection of the same glue 211 as the first embodiment, first circumferentially spaced apart orifices 208 to inject or suction the glue 211, which are formed at the junction between the flared portion 205a and the axial portion 205b axially crossing through that junction and which thus emerge radially facing the annular interstice designed to receive the glue 211 between the radially outer face of the axial portion 205b and the body 202.

Unlike the aforementioned first embodiment, the second circumferentially spaced apart orifices 202a to suction or inject the injected glue 211 or to suction through the first orifices 208, are here not formed at each end-piece 205, but radially through an axially inner zone of the body 202. These second orifices 202a are found immediately below the first seal 210 (i.e., axially toward the outside of the latter), once the body 202 has been guided on each end-piece 205 in contact with the first seal 210 so that it can be radially fitted outside the axial portion 205b until the axially inner end of the body 202 abuts at the bottom of an axial groove 9 at the end-piece 205 (the first seal 210 then bears on the radially inner face of the body 202). The axial groove 9 is radially defined inside by the axial portion 205b and radially outside by an outer axial wall 205c that extends the flared portion 205a parallel to the axial portion 205b over a shorter distance than this axial portion 205b.

Furthermore, this short outer axial wall 205c of the axial groove 9 comprises, on its radially inner face, a groove 205d receiving a second O-ring seal 220 that bears on the radially outer face of the corresponding end of the body 202. As previously explained, the combined use of these first and second seals 210 and 220 makes it possible to optimize the guiding of the body 202, the gluing, the gluing interface 211 and its subsequent protection.

Indeed, after this gluing by vacuum drawing, the glue 211 (which can have a thickness from 0.1 mm to 0.5 mm) covers not only the outer face of the axial portion 205b of each end-piece 205—with the exception of the groove 206, since the gluing interface 211 ends axially outside the first seal 210—and the inner face of the body 202, but also the radial end and the zone of the outer face of the body 202 situated below the second seal 220. In other words, the glue 211 here covers two respective annular zones of the inner and outer faces of the body 202, continuously via the radial end of the latter.

It will be noted that the method for manufacturing a connecting rod according to the invention makes it possible not only to produce connecting rods designed for aeronautic floors, but also all connecting rods of systems or secondary structure, equipment or furniture fastenings, for example like those illustrated in FIGS. 4b and 6.

1. A connecting rod that comprises a tubular body with two ends and two heads for connecting those ends to adjacent structures and that is suitable for reacting primarily axial forces generated by these structures, each head comprising an end-piece flared toward the body and glued on the latter in a gluing interface, wherein the connecting rod comprises at least one first sealing gasket mounted radially between and against the body and the end-piece of each head, axially toward the inside of said gluing interface.

2. The connecting rod according to claim 1, wherein said first sealing gasket, which is annular and preferably an O-ring, is mounted in a first groove formed at an axially inner end of each end-piece.

3. The connecting rod according to claim 2, wherein each end-piece comprises a globally frustoconical flared portion extended axially toward the inside by a globally cylindrical axial portion, the connecting rod incorporating, axially toward the outside of said first sealing gasket, injection and/or suction means of a glue that are able to form said gluing interface on the axial portion of each end-piece, this glue having a viscosity at 25° C. preferably less than or equal to 10 Pa.s.

4. The connecting rod according to claim 3, wherein said injection and suction means comprise a first series of orifices circumferentially spaced apart to inject or suction glue and a second series of orifices circumferentially spaced apart to suction or inject the injected glue or to suction through the first series of orifices, these two series being axially separate from one another.

5. The connecting rod according to claim 4, wherein said first series of orifices is formed through each end-piece substantially at the junction between said flared portion and said axial portion, said second series of orifices being formed through the axial portion or else through said body facing the axial portion.

6. The connecting rod according to claim 5, wherein said first series is formed by first orifices crossing axially through each end-piece radially facing said gluing interface between said body and this end-piece, and in that said second series is formed by second orifices crossing radially through said axial portion of each end-piece or else said body.

7. The connecting rod according to claim 6, wherein said second orifices cross through said axial portion of each end-piece radially outside said body, which is thus topped by this axial portion while being fitted in the end-piece, the glue overlapping at least one radially outer face of the body.

8. The connecting rod according to claim 6, wherein said second orifices cross through said body radially outside said axial portion of each end-piece, and in that each end of the body is wedged in an axial groove of the corresponding end-piece, this axial groove being radially inwardly defined by the axial portion and radially outwardly defined by an outer axial wall that extends said flared portion parallel to the axial portion over a shorter distance than this axial portion, the glue covering at least one radially inner face of the body.

9. The connecting rod according to claim 3, wherein it further comprises, for the connection of each end-piece to said body, at least one annular second sealing gasket or mastic that is mounted in a second groove of each end-piece formed axially facing said axial portion and the corresponding end of said body, said first sealing gasket and this second sealing gasket or mastic being mounted radially on either side of the body and axially opposite one another, the glue covering both the radially inner and outer faces of the body.

10. The connecting rod according to claim 9, wherein for each end-piece, said second groove extends axially from said flared portion radially inside said axial portion, said second sealing gasket or mastic pressing against a radially inner face of the corresponding end of said body .

11. The connecting rod according to claim 9, wherein for each end-piece, said second groove extends over said outer axial wall radially outside said axial portion, said second sealing gasket or mastic pressing against a radially outer face of the corresponding end of said body.

12. The connecting rod according to claim 1, wherein said body, which is pultruded, is based on at least one ply comprising first fibers primarily parallel to a longitudinal axis of symmetry of the body and impregnated with a thermoplastic or thermosetting matrix, and on second wrapping fibers wound in a spiral obliquely around these first fibers, and in that each end-piece, metal or not, is glued on said body by infusion of a resin on each end-piece.

13. The connecting rod according to claim 1, wherein said body and said end-pieces are based on at least one thermoplastic material, and in that each end-piece is not only glued on the body but also mechanically attached to the latter by permanent deformation of the body radially against each end-piece by crimping able to form an assembly stop for the mechanical junction between each end-piece and the body, which is for example pultruded.

14. The connecting rod according to claim 1, wherein each of said heads comprises a connecting end for connecting to said structures that extends said corresponding end-piece axially toward the outside of the body and that is:
of the fixed type, the connecting end in the form of a double yoke including two parallel connecting walls that are formed in a single piece with the end-piece on either side of the median longitudinal plane of the body and that are respectively provided with opposite orifices designed to be crossed through by a connecting pin to one of these structures, or
of the adjustable type, the connecting end including a tubular support inserted adjustably in the end-piece and ending with a double yoke with two parallel connecting walls on either side of the longitudinal median plane of the body, these walls respectively being provided with opposite orifices designed to be crossed through by a connecting pin to one of these structures.

15. An aeronautic floor structure, wherein it includes at least one connecting rod according to claim 1.

16. A method for manufacturing a connecting rod according to claim 1, comprising:
assembling said at least one first sealing gasket in contact with each of said end-pieces and a first radially inner or outer face of an end zone opposite said body , then
gluing each end-piece on the body, by injection and suction of a glue radially between the body and each end-piece and axially toward the outside of this first sealing gasket, the glue having a viscosity at 25° C. preferably less than 1 Pa.s.

17. The method according to claim 16, further comprising mounting at least one second sealing gasket or mastic in contact with each end-piece and with a radially outer or inner second face of said body opposite said first face, said first sealing gasket and said second sealing gasket or mastic thus being mounted radially on either side of the body and axially opposite one another facing a globally cylindrical axial portion of each end-piece.

18. The method according to claim 16, further comprising, prior to said assembly, forming by pultrusion of said body, which is based on at least one ply of fibers impregnated with a thermoplastic or thermosetting matrix, and in that step b) for gluing is implemented by infusion of a resin in contact with each end-piece.
